(19) United States
(12) Patent Application Publication
(10) Pub. No.: US 2011/0143665 A1
(43) Pub. Date: Jun. 16, 2011

(54) METHOD AND APPARATUS FOR MULTIPLE ACCESS FOR DIRECTIONAL WIRELESS NETWORKS

(76) Inventors: Carlos Cordeiro, Portland, OR (US); Solomon Trainin, Haifa (IL)

(21) Appl. No.: 12/638,083

(22) Filed: Dec. 15, 2009

(51) Int. Cl. H04B 7/005

(52) U.S. Cl. 455/41.2

(57) ABSTRACT

A method, system, apparatus and article are described for providing multiple access for directional wireless networks. A method may comprise, for example, establishing a distributed contention-based period (CBP) for a directional wireless network and transmitting information from a first device to a second device based on one or more distributed CBP rules, wherein the transmission comprises a directional transmission. Other embodiments are described and claimed.

### BACKGROUND

Wireless communication systems communicate information over a shared wireless communication medium such as one or more portions of the radio-frequency (RF) spectrum. Recent innovations in Millimeter-Wave (mmWave) communications operating at the 60 Gigahertz (GHz) frequency band promises several Gigabits-per-second (Gbps) throughput within short ranges of approximately 10 meters. The limited range and directionality of mmWave communications systems results in the possibility that a large number and variety of devices could be used within the same wireless network. Centralized scheduled access to the communications medium has been used to improve performance in some systems. Conventional techniques typically rely on a central coordinator (PCP or AP) to regulate access to the communications medium which does not allow for spatial reuse. Consequently, techniques designed to distribute access to the communications medium and enhance spatial reuse in wireless communications systems are desirable.

### BRIEF DESCRIPTION OF THE DRAWINGS

FIG. 1 illustrates one embodiment of a communications system.

FIG. 2A illustrates one embodiment of a first timing diagram.

FIG. 2B illustrates one embodiment of a second timing diagram.

FIG. 3A illustrates one embodiment of a first transmission diagram.

FIG. 3B illustrates one embodiment of a second transmission diagram.

FIG. 4A illustrates one embodiment of a third transmission diagram.

FIG. 4B illustrates one embodiment of a fourth transmission diagram.

FIG. 5 illustrates one embodiment of a logic flow.

FIG. 6 illustrates one embodiment of an article of manufacture.

### DETAILED DESCRIPTION

Various embodiments may be generally directed to multiple access for directional wireless networks. Some embodiments may be particularly directed to an enhanced method for distributed access in a directional wireless network, such as a 60 GHz mmWave wireless network, for example. Such networks are sometimes referred to as “piconets” or personal basic service set (PBSS) due to their limited transmission ranges and participating devices. The enhanced distributed access method may allow for spatial reuse in the wireless network, thereby allowing a plurality of devices to simultaneously communicate, resulting in improved network performance for directional wireless networks.

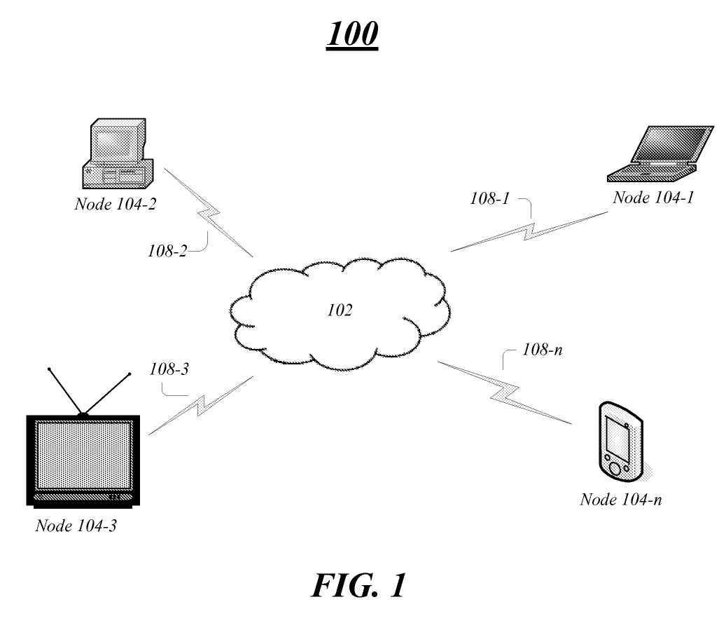

FIG. 1 illustrates a block diagram of one embodiment of a communications system 100. In various embodiments, the communications system 100 may comprise multiple nodes. A node generally may comprise any physical or logical entity for communicating information in the communications system 100 and may be implemented as hardware, software, or any combination thereof, as desired for a given set of design parameters or performance constraints. Although FIG. 1 may show a limited number of nodes by way of example, it can be appreciated that more or less nodes may be employed for a given implementation.

In various embodiments, the communications system 100 may comprise, or form part of a wired communications system, a wireless communications system, or a combination of both. For example, the communications system 100 may include one or more nodes arranged to communicate information over one or more types of wired communication links. Examples of a wired communication link, may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The communications system 100 also may include one or more nodes arranged to communicate information over one or more types of wireless communication links. Examples of a wireless communication link may include, without limitation, a radio channel, infrared channel, radio-frequency (RF) channel, Wireless Fidelity (WiFi) channel, a portion of the RF spectrum, and/or one or more licensed or license-free frequency bands.

The communications system 100 may communicate information in accordance with one or more standards as promulgated by a standards organization. In one embodiment, for example, various devices comprising part of the communications system 100 may be arranged to operate in accordance with one or more of the IEEE 802.11 standard, the WiGig Alliance™ specifications, WirelessHD™ specifications, standards or variants, such as the WirelessHD Specification, Revision 1.0d7, Dec. 1, 2007, and its progeny as promulgated by WirelessHD, LLC (collectively referred to as the “WirelessHD Specification”), or with any other wireless standards as promulgated by other standards organizations such as the International Telecommunications Union (ITU), the International Organization for Standardization (ISO), the International Electrotechnical Commission (IEC), the Institute of Electrical and Electronics Engineers (information IEEE), the Internet Engineering Task Force (IETF), and so forth. In various embodiments, for example, the communications system 100 may communicate information according to one or more IEEE 802.11 standards for wireless local area networks (WLANs) such as the information IEEE 802.11 standard (1999 Edition, Information Technology Telecommunications and Information Exchange Between Systems—Local and Metropolitan Area Networks—Specific Requirements, Part 11: WLAN Medium Access Control (MAC) and Physical (PHY) Layer Specifications), its progeny and supplements thereto (e.g., 802.11a, b, g/h, j, n, VHT SG, and variants); IEEE 802.15.3 and variants; IEEE 802.16 standards for WMAN including the IEEE 802.16 standard such as 802.16-2004, 802.16.2-2004, 802.16e-2005, 802.16f, and variants; WGA (WiGig) progeny and variants; European Computer Manufacturers Association (ECMA) TG20 progeny and variants; and other wireless networking standards. The embodiments are not limited in this context.

The communications system 100 may communicate, manage, or process information in accordance with one or more protocols. A protocol may comprise a set of predefined rules or instructions for managing communication among nodes. In various embodiments, for example, the communications system 100 may employ one or more protocols such as a beam forming protocol, medium access control (MAC) protocol, Physical Layer Convergence Protocol (PLCP), Simple Network Management Protocol (SNMP), Asynchronous Transfer Mode (ATM) protocol, Frame Relay protocol, Systems Network Architecture (SNA) protocol, Transport Control Protocol (TCP), Internet Protocol (IP), TCP/IP, X.25, Hypertext Transfer Protocol (HTTP), User Datagram Protocol (UDP), a contention-based period (CBP) protocol, a distributed contention-based period (CBP) protocol and so forth. In various embodiments, the communications system 100 also may be arranged to operate in accordance with standards and/or protocols for media processing. The embodiments are not limited in this context.

As shown in FIG. 1, the communications system 100 may comprise a network 102 and a plurality of nodes 104-1-n, where n may represent any positive integer value. In various embodiments, the nodes 104-1-n may be implemented as various types of wireless devices. Examples of wireless devices may include, without limitation, an IEEE 802.15.3 piconet controller (PNC), a controller, an IEEE 802.11 PCP, a coordinator, a station, a subscriber station, a base station, a wireless access point (AP), a wireless client device, a wireless station (STA), a laptop computer, ultra-laptop computer, portable computer, personal computer (PC), notebook PC, handheld computer, personal digital assistant (PDA), cellular telephone, combination cellular telephone/PDA, smartphone, pager, messaging device, media player, digital music player, set-top box (STB), appliance, workstation, user terminal, mobile unit, consumer electronics, television, digital television, high-definition television, television receiver, high-definition television receiver, and so forth.

In some embodiments, the nodes 104-1-n may comprise one more wireless interfaces and/or components for wireless communication such as one or more transmitters, receivers, transceivers, chipsets, amplifiers, filters, control logic, network interface cards (NICs), antennas, antenna arrays, modules and so forth. Examples of an antenna may include, without limitation, an internal antenna, an omni-directional antenna, a monopole antenna, a dipole antenna, an end fed antenna, a circularly polarized antenna, a micro-strip antenna, a diversity antenna, a dual antenna, an antenna array, and so forth.

In various embodiments, the nodes 104-1-n may comprise or form part of a wireless network 102. In one embodiment, for example, the wireless network 102 may comprise a Millimeter-Wave (mmWave) wireless network operating at the 60 Gigahertz (GHz) frequency band. Although some embodiments may be described with the wireless network 102 implemented as a Millimeter-Wave (mmWave) wireless network for purposes of illustration, and not limitation, it can be appreciated that the embodiments are not limited in this context. For example, the wireless network 102 may comprise or be implemented as various types of wireless networks and associated protocols suitable for a WPAN, a Wireless Local Area Network (WLAN), a Wireless Metropolitan Area Network, a Wireless Wide Area Network (WWAN), a Broadband Wireless Access (BWA) network, a radio network, a television network, a satellite network such as a direct broadcast satellite (DBS) network, and/or any other wireless communications network configured to operate in accordance with the described embodiments.

In various embodiments, a conventional Millimeter-Wave (mmWave) wireless network operating at the 60 Gigahertz (GHz) frequency band may include one of nodes 104-1-n that acts as a central coordinator node. The coordinator node may be operative to control the timing in the PBSS, keep track of the members of the PBSS, and may be operative to transmit and receive data. The remaining nodes 104-1-n may comprise stations that are operative transmit and receive data. Other embodiments are described and claimed.

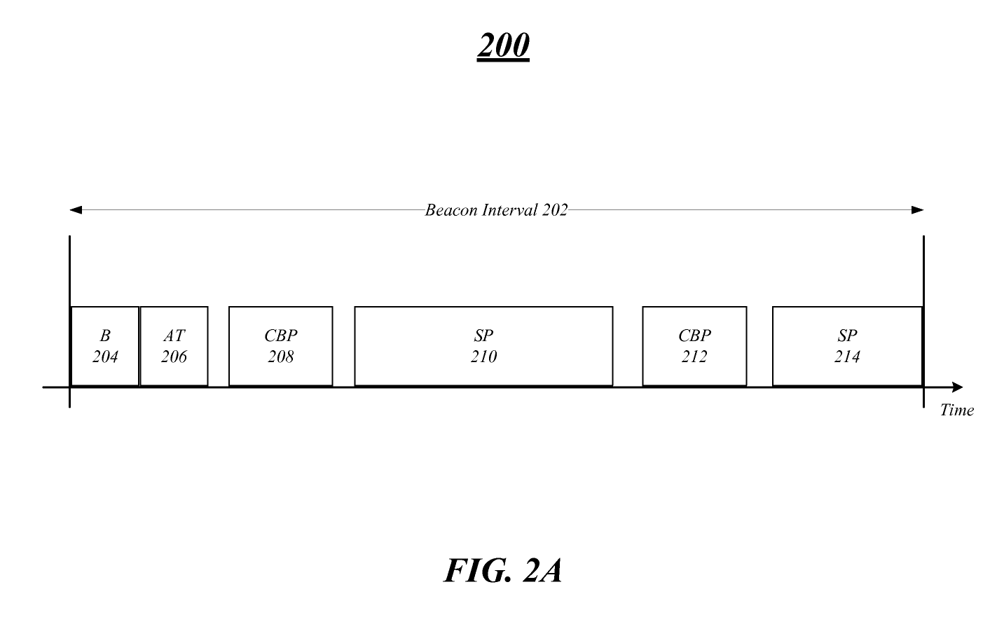

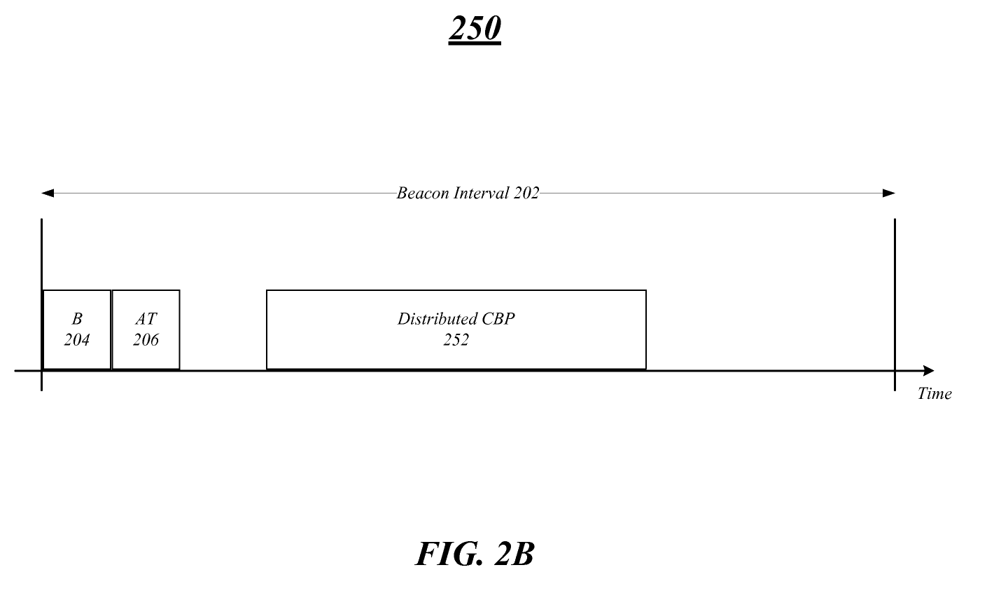

FIG. 2A illustrates a timing diagram 200 for a possible implementation of a future 60 GHz network that relies on a central coordinator node. As shown in FIG. 2A, the Beacon Interval (BI) 202 structure/scheduling may include a Beacon (B) 204, an Announcement Time (AT) 206, contention-based periods (CBPs) 208 and 212 and service periods (SPs) 210 and 214. While a limited number element are shown in FIG. 2A for purposes of illustration, it should be understood that any number of type or scheduling signals or logic may be used and still fall within the described embodiments.

In some embodiments, the central coordinator (PCP) schedules time in the BI for stations (STAs) (e.g. nodes 104-1-n) to communicate. The periods of time scheduled in the BI can be of two types: SP and CBP. The schedule of SPs and CBPs in a BI is transmitted in the Beacon 204 or AT 206. In conventional networks, the SP is owned by a single source STA that controls access to the medium during the SP duration. During the CBP, on the other hand, multiple STAs (potentially all of nodes 104-1-n of FIG. 1, for example) are allowed to contend for medium access using a protocol similar to the carrier sense multiple access with collision avoidance (CSMA/CA) protocol typically used in IEEE 802.11 standards, for example.

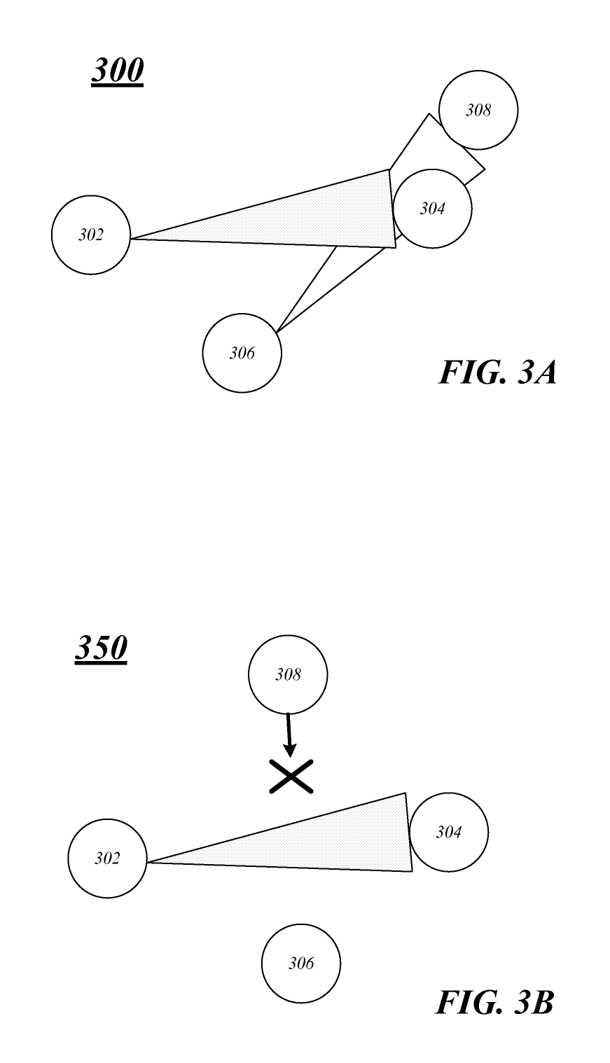

In some embodiments, however, due to the fact that directional communication is used in 60 GHz wireless network, the traditional CSMA/CA approach as defined in the IEEE 802.11 specifications may not be applicable since both virtual and physical carrier sense may not be reliable. FIG. 3A illustrates a transmission diagram showing an example of why carrier sense is unreliable in 60 GHz networks. As shown in FIG. 3A, a wireless network 300 includes nodes 302, 304, 306 and 308 which may the same or similar to nodes 104-1-n in FIG. 1. In some embodiments, node 302 may be transmitting to node 304 and during this transmission node 306 may sense the channel in an attempt to initiate transmission to node 308. As shown in FIG. 3A, node 306 may not detect any carrier, and may initiate transmission to node 308, causing a collision at node 304 and thereby degrading performance of the network 300.

As previously stated, in some embodiments a PCP-centric (e.g. central coordinator node) approach to support CSMA/CA like operation in 60 GHz wireless networks has been proposed to address these and other problems associated with directional wireless networks. In some embodiments, the PCP completely manages access to the wireless medium during a CBP period. While this approach is able to address the directionality issue in 60 GHz wireless network as illustrated in FIG. 3A, the PCP-centric approach has several disadvantages. For example, in some embodiments, a PCP-centric approach is unable to exploit spatial reuse within a wireless network as indicated in FIG. 3A. In various embodiments, because directional protections are established for all STAs in the wireless network 300 in a PCP-centric approach, node 308 is simply not allowed to transmit to node 306 while node 302 is communicating with node 304, as shown in wireless network 350 of FIG. 3B, which may be the same or similar to wireless network 300 of FIG. 3A.

In some embodiments, a PCP-centric approach also requires the PCP to be awake during each CBP period in a BI, thereby increasing PCP power consumption. This may be problematic in situations where, for example, the PCP comprises a mobile computing device with limited power capacity. A PCP-centric approach may also be a complex and onerous approach for simple usages of the wireless network, such as sync&go between two low complexity mobile devices, for example. In addition to the above stated problems, directionality aspects of the wireless network such as collision detection and resynchronization may be challenging or impractical to guarantee in 60 GHz wireless networks.

Another challenge presented when a PCP-centric approach to medium access in directional networks is utilized is how beamforming (BF) is performed during a CBP. One problem with performing beamforming in a PCP-centric scheduled access wireless network is that STAs may lose time synchronization with one another, thereby preventing successful completion of the beamforming operation during a CBP. For example, in the wireless network 300 of FIG. 3A, node 302 may start the BF procedure with node 304 during a CBP (such as CBP 208 of FIG. 2A, for example) so as to discover the direction for their communication. In various embodiments, unless both nodes 302 and 304 always complete each phase of the BF procedure contiguously in time, there may be a synchronization problem due to the CSMA/CA access to the channel during the CBP. In some embodiments, because the CSMA/CA is a random channel access scheme, the next time at which either node 302 or node 304 is able to access the channel to continue an interrupted BF procedure is not deterministic. This may lead, for example, to the problem that the STAs may lose synchronization and may never succeed in completing BF during the CBP 208 and may need to attempt to resume beamforming during CBP 212, which may by difficult to synchronize.

The foregoing represent are only a few examples of the problems that may be overcome by implementing a distributed multiple access scheme for directional wireless networks, and it may be appreciated that other problems may be overcome and other advantages may exist as well.

FIG. 2B illustrates a timing diagram 250 for one embodiments of a 60 GHz network that does not rely exclusively on a central coordinator node and allows for distributed access to the communications medium. As shown in FIG. 2A, the Beacon Interval (BI) 202 structure/scheduling may include a Beacon (B) 204, an Announcement Time (AT) 206 and a distributed contention-based period (CBP) 252. While a limited number element are shown in FIG. 2B for purposes of illustration, it should be understood that any number or type of scheduling signals or logic may be used and still fall within the described embodiments. For example, while not shown in FIG. 2B, it should be understood that the contention-based periods (CBPs) 208 and 212 and service periods (SPs) 210 and 214 could also be implemented at different times in the network represented by timing diagram 250, along with distributed CBP 252, and still fall within the described embodiments.

In various embodiments, distributed CBP 252 may comprise a contention-based period wherein any node in a directional wireless network is able to initiate transmission to any other node at any time as long as a set of distributed contention-based period (CBP) rules are followed. In some embodiments, a wireless device, such as any of nodes 104-1-n of FIG. 1, may be operative to establish a distributed CBP 252 for a directional wireless network and transmit information to another wireless device based on the one or more distributed CBP rules. Other embodiments are described and claimed.

In some embodiments, a first distributed CBP rule may require all transmissions to use a standard frame format. For example, the PHY and MAC frame formats used for data transfers during the distributed CBP should not differ from those used for any other access methods in the wireless network, like CSMA or TDMA. Ensuring that the same frame formats are used for data transfer when using each access method may result in compatibility among devices and access methods in the wireless network.

A second distributed CBP rule may require all transmissions to use a standard interframe spacing (IFS). For example, the IFS used during the distributed CBP should not differ from the IFS used for any other access methods available in the wireless network. Stated differently, no station or node in the wireless network should transmit a PPDU sequence separated by IFS that differs from the IFS defined in the PHY and MAC specification, for example. This may also result in improved compatibility for the devices of the wireless network.

In various embodiments, a third distributed CBP rule may require that all acknowledgements associated with the distributed CBP follow a standard acknowledgement procedure and format. For example, the acknowledgement mechanism associated with the distributed CBP should use the acknowledgement schemes defined in the PHY and MAC specification for centralized or scheduled access to ensure compatibility.

In some embodiments, a fourth distributed CBP rule may require that all transmissions during the distributed CBP be directional transmissions. In this manner, spatial reuse can be exploited, for example. It should be understood that each of the four above-recited distributed CBP rules should be followed to enable distributed access by a plurality of nodes in a directional wireless network. In some embodiments, the distributed CBP rules allow for the same data transmission state machine with the same parameters to be used for any access method, which enables easy switching between different access methods (e.g. from distributed CBP to centralized CBP to scheduled SP, for example). Other embodiments are described and claimed.

In addition to the above stated distributed CBP rules, other optional rules may also be implemented and used in various embodiments to improve or alter performance. For example, physical and/or virtual carrier sense may be used and a STA or node may employ backoff procedures if it determines that a channel is busy. In some embodiments, a STA or node may respect established protections and may not initiate a transmission until the protections are reset or removed. The embodiments are not limited in this context.

In some embodiments, to ensure that a given STA or node does not occupy a channel for a long period of time and defers access to other STAs, it may be advantageous to limit the maximum frame transmission duration in the distributed CBP. This would allow a less contentious access during the CBP and would prevent any one STA from occupying the entire channel.

In various embodiments, implementing the above described distributed CBP rules may allow for the definition of a distributed CBP specification and for devices that are interoperable, while at the same time defining a distributed random access scheme that is simple and is able to take advantage of spatial reuse when directional communication at 60 GHz is used.

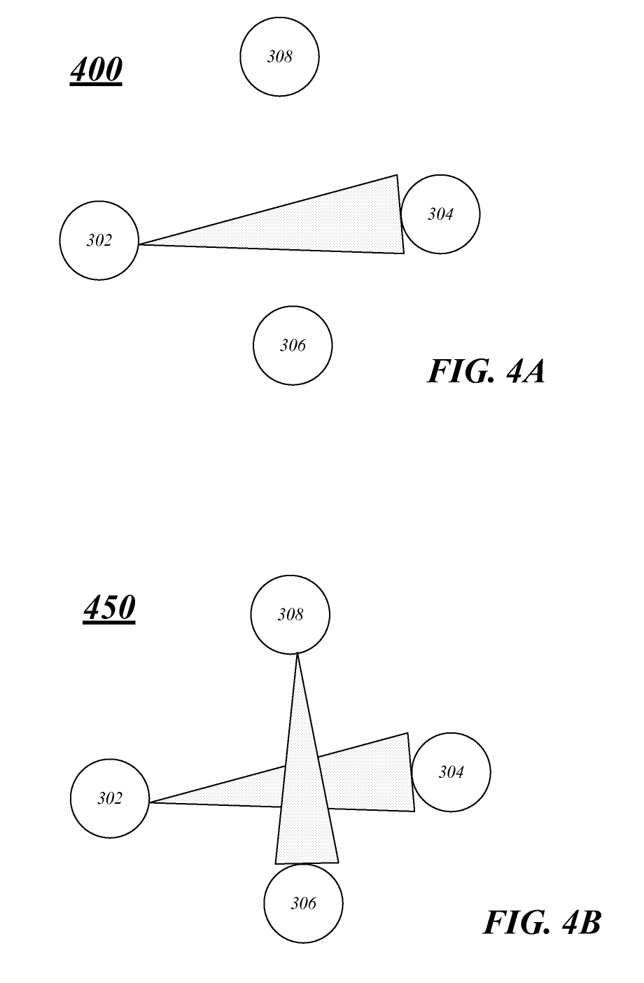

FIGS. 4A and 4B illustrate example transmission diagrams for wireless networks 400 and 450 in some embodiments. Wireless networks 400 and 450 may represent, in some embodiments, wireless networks implementing a distributed CBP scheme and disturbed CBP rules as described above. Wireless networks 400 and 450 may include nodes 302, 304, 306 and 308 which may the same or similar to nodes 104-1-n of FIG. 1 and/or nodes 302, 304, 306 and 308 of FIGS. 3A and 3B. In some embodiments, the nodes 303, 304, 306 and 3-8 may comprise wireless devices in configured and/or operative to communication in a mmWave wireless network 400, 450, for example. While a limited number of elements are shown by way of example, it should be understood than any number or arrangement of nodes could be used and still fall within the described embodiments.

As shown in FIG. 4A, node 302 may perform no backoff or carrier sense prior to transmitting a frame directly to node 304. In various embodiments, node 304 may be in quasi-omni receive mode during this period, and if needed may switch to directional mode after it detects the frame from node 302. In some embodiments, nodes 302 and 304 may or may not perform beamforming with each other prior to the transmission. For example, if nodes 302 and 304 comprise two single antenna sync&go STAs or wireless devices, a transmission may be possible without beamforming. The embodiments are not limited in this context.

In various embodiments, as shown in FIG. 4B, during the communication between nodes 302 and 304 or simultaneous with the establishment of the connection between nodes 302 and 304, node 308 may initiate a transmission to node 306. In some embodiments, if the disturbed CBP rules are followed by node 308, the transmission to node 306 may begin immediately without regard for the connection between nodes 302 and 304. As shown in FIG. 4B, the transmission from node 308 and node 306 may be successful despite the ongoing transmission between nodes 302 and 304. In some embodiments, both transmissions may proceed concurrently and spatial reuse may be exploited during the distributed CBP when the disturbed CBP rules are followed. Other embodiments are described and claimed.

In some embodiments, the transmissions between nodes 302 and 304 and 308 and 306 may interfere. In this situation, in various embodiments, it may be advantageous for the individual nodes to independently decide (rather than having a PCP decide), after a few retries for example, to implement a backoff procedure or to stop using the distributed CBP completely and switch to using a centralized CBP. In switching to the centralized CBP, the nodes may be operative to follow the traditional CSMA/CA backoff rules and be afforded the protection for their transmission in various embodiments.

In various embodiments, beamforming may be utilizing in connection with the distributed CBP in the directional wireless network. For example, beamforming may be used to establish directional connections in some embodiments. As recited above, however, synchronization in beamforming may be problematic when limited duration CBPs and distributed CBPs are applied. For example, it may be difficult to synchronize beamforming for two devices if the devices are unable to complete the beamforming during a given CBP. To address this problem in a wireless network implementing a distributed CBP scheme, an exception to the CBP rules may apply in various embodiments. In some embodiments, when beamforming is initiated for a distributed CBP, the distributed CBP rules may not apply.

In various embodiments, a beamforming initiator or responder (e.g. source or destination STAs or node) that started beamforming during a CBP but did not complete beamforming within the CBP because the end of the CBP was reached, may resume the beamforming procedure at the start of the next CBP without having to perform or abide by the distributed CBP rules. Stated differently, the STA or node may access the distributed CBP or CBP immediately without any deferrals in the specific case when BF was initiated in the previous CBP but was not completed in the previous CBP. Other embodiments are described and claimed.

Operations for various embodiments may be further described with reference to the following figures and accompanying examples. Some of the figures may include a logic flow. It can be appreciated that an illustrated logic flow merely provides one example of how the described functionality may be implemented. Further, a given logic flow does not necessarily have to be executed in the order presented unless otherwise indicated. In addition, a logic flow may be implemented by a hardware element, a software element executed by a processor, or any combination thereof. The embodiments are not limited in this context.

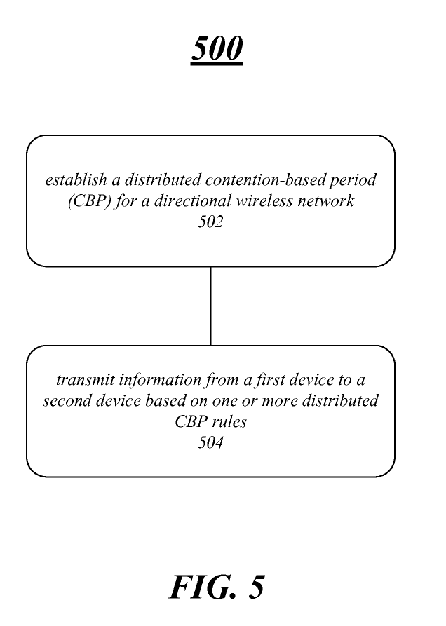

FIG. 5 illustrates one embodiment of a logic flow 500 for enabling multiple access in a directional wireless network. In various embodiments, the logic flow 500 may be performed by various systems, nodes, and/or modules and may be implemented as hardware, software, and/or any combination thereof, as desired for a given set of design parameters or performance constraints. For example, the logic flow 500 may be implemented by a logic device (e.g., node, STA, wireless device) and/or logic comprising instructions, data, and/or code to be executed by a logic device. For purposes of illustration, and not limitation, the logic flow 500 is described with reference to FIGS. 1 and 2B. The embodiments are not limited in this context.

In various embodiments, the logic flow 500 establishes a distributed contention-based period (CBP) for a directional wireless network at 502. For example, any of wireless devices 104-1-n may establish a distributed CBP for network 102, which may comprise a 60 GHz mmWave directional wireless network. In a particular embodiment, it may be the responsibility of the central station (e.g., PCP or AP) to schedule time within the BI 202 for a distributed CBP 252. The embodiments are not limited in this context.

In one embodiment, for example, the logic flow 500 may transmit information from a first device to a second device based on one or more distributed CBP rules at 504. For example, wireless device 104-1 may transmit information to wireless device 104-2 using a standard frame format for the wireless network 102, a standard interframe spacing for the wireless network 102 and standard acknowledgement procedures for wireless network 102. The use of a standard frame format, a standard interframe spacing and a standard acknowledgement procedure may comprise all or part of the distributed CBP rules in some embodiments. In various embodiments, the distributed CBP rules may be selected such that transmissions are the same for each of a plurality of access methods available for a wireless network.

The transmission from wireless device 104-1 to wireless device 104-2 may comprise a directional transmission established using beamforming between the wireless devices in some embodiments. In some embodiments, establishment of the disturbed CBP rules may allow for the simultaneous transmission of information from a plurality of devices of the wireless network. For example, devices 104-1 and 104-3 may initiate transmissions to devices 104-2 and 104-n respectively and simultaneously based on the distributed CBP rules. In some embodiments, each simultaneous transmission may comprise a directional transmission. The embodiments are not limited in this context.

In various embodiments, a maximum transmission duration may be established for the disturbed CBP. For example, to prevent any one device from completely occupying the channel, a limit may be set for the amount of time that each device may access the channel. Other embodiments are described and claimed.

In addition to or in place of the disturbed CBP, a CBP may be established in some embodiments that provides directional protection for devices and allows for the coordination of transmissions by a plurality of different devices at different times. For example, a central coordinator node (e.g., PCP or AP) may be implemented that coordinates access to wireless network 102, allowing only a limited number of devices to access the channel at any given time. The embodiments are not limited in this context.

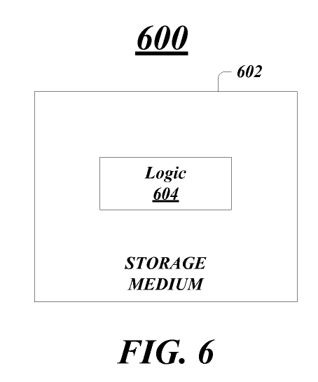

FIG. 6 illustrates one embodiment of an article of manufacture 600. As shown, the article 600 may comprise a storage medium 602 to store logic 604 for establishing a disturbed CBP for a directional wireless network and for implementing directional CBP rules for the transmission of information during the distributed CBP. For example, logic 604 may be used to implement a connection management module for a mobile computing device, node or other system, as well as other aspects of nodes 104-1-n, for example. In various embodiments, the article 600 may be implemented by various systems, nodes, and/or modules.

The article 600 and/or machine-readable storage medium 602 may include one or more types of computer-readable storage media capable of storing data, including volatile memory or, non-volatile memory, removable or non-removable memory, erasable or non-erasable memory, writeable or re-writeable memory, and so forth. Examples of a machine-readable storage medium may include, without limitation, random-access memory (RAM), dynamic RAM (DRAM), Double-Data-Rate DRAM (DDR-DRAM), synchronous DRAM (SDRAM), static RAM (SRAM), read-only memory (ROM), programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other type of computer-readable storage media suitable for storing information. Moreover, any media involved with downloading or transferring a computer program from a remote computer to a requesting computer carried by data signals embodied in a carrier wave or other propagation medium through a communication link (e.g., a modem, radio or network connection) is considered computer-readable storage media.

The article 600 and/or machine-readable medium 602 may store logic 604 comprising instructions, data, and/or code that, if executed by a machine, may cause the machine to perform a method and/or operations in accordance with the described embodiments. Such a machine may include, for example, any suitable processing platform, computing platform, computing device, processing device, computing system, processing system, computer, processor, or the like, and may be implemented using any suitable combination of hardware and/or software.

The logic 604 may comprise, or be implemented as, software, a software module, an application, a program, a subroutine, instructions, an instruction set, computing code, words, values, symbols or combination thereof. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context. When implemented the logic 1104 is implemented as software, the software may be executed by any suitable processor and memory unit.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It is also worthy to note that any reference to “one embodiment” or “an embodiment” means that a particular feature, structure, or characteristic described in connection with the embodiment is included in at least one embodiment. Thus, appearances of the phrases “in one embodiment” or “in an embodiment” in various places throughout the specification are not necessarily all referring to the same embodiment. Furthermore, the particular features, structures or characteristics may be combined in any suitable manner in one or more embodiments.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. A method, comprising:
establishing a distributed contention-based period (CBP) for a directional wireless network; and
transmitting information from a first device to a second device based on one or more distributed CBP rules, wherein the transmission comprises a directional transmission.

2. The method of claim 1, the distributed CBP rules comprising:
transmitting information using a standard frame format;
transmitting information using a standard interframe spacing; and
acknowledging transmission using a standard acknowledgement procedure.

3. The method of claim 2, wherein the standard frame format, the standard interframe spacing, and the standard acknowledgment procedure are the same for each of a plurality of access methods available for the wireless network.

4. The method of claim 1, comprising:
simultaneously transmitting information from a plurality of devices of the wireless network based on the distributed CBP rules, wherein each transmission comprises a directional transmission.

5. The method of claim 1, wherein the directional transmission is established using beamforming.

6. The method of claim 1, comprising:
establishing a maximum transmission duration for the distributed CBP.

7. The method of claim 1, comprising:
coordinating transmission for a plurality of devices at different times.

8. The method of claim 1, wherein the wireless network comprises a Millimeter-Wave (mmWave) directional wireless network.

9. An apparatus, comprising:
a wireless device including a transceiver operative to establish a distributed contention-based period (CBP) for a directional wireless network and transmit information to another wireless device based on one or more distributed CBP rules, wherein the transmission comprises a directional transmission.

10. The apparatus of claim 9, the distributed CBP rules comprising:
transmitting information using a standard frame format;
transmitting information using a standard interframe spacing; and
acknowledging transmission using a standard acknowledgement procedure.

11. The apparatus of claim 10, wherein the standard frame format, the standard interframe spacing, and the standard acknowledgment procedure are the same for each of a plurality of access methods available for the wireless network.

12. The apparatus of claim 9, the wireless network operative to accommodate a plurality of different transmissions from a plurality of devices at the same time based on the distributed CBP rules, wherein each transmission comprises a directional transmission.

13. The apparatus of claim 9, wherein the directional transmission is established using beamforming.

14. The apparatus of claim 9, the distributed CBP including a maximum transmission duration.

15. The apparatus of claim 9, wherein the wireless device is operative to receive coordination information from a central coordinating device to coordinate transmissions with a plurality of wireless devices at different times.

16. The apparatus of claim 9, wherein the wireless device is operative to communicate in a Millimeter-Wave (mmWave) directional wireless network.

17. An article comprising a computer-readable storage medium containing instructions that if executed by a processor enable a system to:
establish a distributed contention-based period (CBP) for a directional wireless network; and
transmit information from a first device to a second device based on one or more distributed CBP rules, wherein the transmission comprises a directional transmission.

18. The article of claim 17, further comprising instructions that if executed enable a system to establish distributed CBP rules to:
transmit information using a standard frame format;
transmit information using a standard interframe spacing; and
acknowledge transmission using a standard acknowledgement procedure.

19. The method of claim 18, wherein the standard frame format, the standard interframe spacing, and the standard acknowledgment procedure are the same for each of a plurality of access methods available for the wireless network.

20. The article of claim 17, further comprising instructions that if executed enable a system to:
establish a plurality of different wireless connections at the same time based on the distributed CBP rules, wherein each wireless connection comprises a directional transmission.

21. The article of claim 17, further comprising instructions that if executed enable a system to:
establish the directional transmission using beamforming.

22. The article of claim 17, further comprising instructions that if executed enable a system to:
establish a maximum transmission duration for the distributed CBP.

23. The article of claim 17, further comprising instructions that if executed enable a system to:
coordinate transmission for a plurality of devices at different times.

24. The article of claim 17, wherein the wireless network comprises a Millimeter-Wave (mmWave) directional wireless network.

25. A system, comprising:
a wireless device including a digital display and a transceiver operative to establish a distributed contention-based period (CBP) for a directional wireless network and transmit information to another wireless device based on one or more distributed CBP rules, wherein the transmission comprises a directional transmission.

26. The system of claim 25, the distributed CBP rules comprising:
transmitting information using a standard frame format;
transmitting information using a standard interframe spacing; and
acknowledging transmission using a standard acknowledgement procedure.

27. The system of claim 26, wherein the standard frame format, the standard interframe spacing, and the standard acknowledgment procedure are the same for each of a plurality of access methods available for the wireless network.

28. The system of claim 25, the wireless network operative to accommodate a plurality of transmissions from a plurality of devices at the same time based on the distributed CBP rules, wherein each transmission comprises a directional transmission.

29. The system of claim 25, wherein the directional transmission is established using beamforming.

30. The system of claim 25, wherein the wireless network comprises a Millimeter-Wave (mmWave) directional wireless network.
